(19) United States
(12) Patent Application Publication
(10) Pub. No.: US 2011/0007162 A1
(43) Pub. Date: Jan. 13, 2011

(54) METHOD AND DEVICE FOR IMAGE DETECTION FOR MOTOR VEHICLES

(76) Inventor: Karsten Haug, Stuttgart (DE)

Correspondence Address: KENYON & KENYON LLP, ONE BROADWAY, NEW YORK, NY, 10004, US

(21) Appl. No.: 12/735,240

(22) PCT Filed: Nov. 11, 2008
(86) PCT No.: PCT/EP2008/065264

§ 371 Date: Sep. 28, 2010

(30) Foreign Application Priority Data
Jan. 10, 2008 (DE) 10 2008 003 800.8

(51) Int. Cl. H04N 7/18

(52) U.S. Cl. 348/148; 348/E07.085

(57) ABSTRACT

An image sensing method for motor vehicles, an image of the surroundings of the vehicle being sensed by way of pixels of an image sensor, and exposure parameters of at least one pixel of the image sensor being set. Different exposure parameters are set for at least two of the pixels at the same point in time. An apparatus for carrying out this method is also described.

### BACKGROUND OF THE INVENTION

1. Field of the Invention

The present invention relates to a method and an apparatus for image sensing for motor vehicles, an image sensor integrated into a camera being used.

2. Description of Related Art

Driver assistance systems, for example night vision systems or lane assistance systems, in which cameras are used for observation of the surroundings, have recently been increasingly used to assist the drivers of motor vehicles. The surroundings of an automobile have proven to be a particularly demanding environment for the use of such camera, which can be implemented e.g. for use of a CMOS or CCD image sensor. The exposure conditions change in extremely dynamic fashion, for example, when entering a tunnel during the day or even in an urban environment. Stringent requirements must furthermore be applied in terms of the depth of field of the systems used, so that the driver can be provided with the most comprehensive information possible regarding the situation at different distances. In addition, both extremely fast-moving objects as well as almost static regions are usually located in the camera's field of view.

A variety of solutions have been proposed in the past in order to be able to meet these requirements. Published German Patent Application Document DE 10 2004 047 476 A1, for example, discloses an apparatus and a method for setting a camera, in which apparatus and method the exposure parameters for a camera are set on the basis of selected image regions, for example as a function of the location of the horizon. The gain and/or offset and/or integration time or aperture can be used in this context, for example, as exposure parameters. In addition, Published German Patent Application Document DE 103 18 499 A1 describes a method and an apparatus for setting an image sensor in which, once again, the aforesaid parameters of an image sensor are set on the basis of selected regions of an acquired image.

Published German Patent Application Document DE 103 01 898 A1 describes a method in which the optimum characteristic curve for illumination sensitivity for the pixels of an image sensor is ascertained from the histogram of the grayscale values of at least one image; the aforesaid characteristic curve is selected in such a way that it conforms at least approximately to the optimum characteristic curve. A definition of the characteristic curve, as well as examples thereof, are provided in the aforesaid document.

The above-described apparatuses and methods of the existing art are disadvantageous, however, in that none of the aforesaid apparatuses or methods takes account of the fact that conditions across the image can turn out to be extremely different in various regions of the image. The problem of so-called motion blur, in particular, is solved only insufficiently in the existing art. The aforesaid problem of motion blur arises essentially from the fact that dark image regions are exposed long enough that the information contained in them can still be resolved. The result of this, however, is that because of the long exposure time required, moving objects are imaged in blurred fashion, so because of the vehicle's own motion, both stationary objects such as e.g. traffic signs, or even other inherently moving objects such as e.g. crossing vehicles or pedestrians, are recognizable only in distorted fashion in the camera image. Because the aforementioned existing art sets the exposure parameters for the entire image in each case, the regions in which the aforesaid highly relevant objects are present are generally depicted inadequately.

### SUMMARY OF THE INVENTION

An advantage of the invention is that the exposure parameters of the image sensor can be selected in a manner adapted for each image region, so that each part of the resulting image is sensed under optimum imaging conditions. This is achieved by the fact that during acquisition of the image by means of an image sensor having pixels arranged, for example, in rows and columns, the exposure parameters of at least one pixel of the image sensor are set in such a way that different exposure parameters can be set at the same point in time for at least two of the pixels. This makes possible, for example, an optimized combination of a lane departure warning function with traffic sign detection. This is based on the fact that even in dark scenes, the vehicle's lane can be effectively resolved because it is possible to work with maximum exposure times in the image regions corresponding to the lane. Conversely, the invention makes it possible for traffic signs, which have considerable brightness especially at short range because they are illuminated by the vehicle headlights, to be imaged sharply, because the exposure time can be reduced in those image regions in which the traffic signs are to be expected (typically at the edge regions of the lane). In this context, a set of exposure parameters can contain, for example, the parameters (known from the documents cited above) of an exposure characteristic curve, or the exposure time. The exposure characteristic curve can exhibit a monotonically linear, locally linear, or logarithmic profile. The data made available by an assistance system, in particular an adaptive cruise control (ACC) or navigation system, can furthermore be used to set the exposure parameters.

### BRIEF DESCRIPTION OF THE SEVERAL VIEWS OF THE DRAWINGS

The invention will be explained in further detail below with reference to embodiments described in the drawings, in which:

FIG. 1 is an exemplifying camera image, subdivided into two regions.

FIG. 2 is a flow chart to illustrate the method according to the present invention.

### DETAILED DESCRIPTION OF THE INVENTION

An advantage of the method referred to is that different exposure parameters can be respectively set for the pixels of at least two continuous regions of a row or column of the image; in the extreme case, a separate set of exposure parameters can in fact be set for each pixel of a row or column.

The above-described procedure can be used to overlay a correction matrix, statically or dynamically, onto the previously known exposure control system for the entire image, i.e. the use of a uniform exposure parameter set for the entire image, in order to reduce the aforesaid problem of motion blur. The correction matrix allows the exposure parameters to be elevated or attenuated in a specific region. This results in shorter maximum exposure times in an attenuated region, whereas it causes longer exposure times in an elevated region. When the pixels are outputted for an image output unit or a driver assistance system via a data interface, the acquired intensity values can be converted into grayscale values in consideration of the exposure parameters or of the selected characteristic curve, so that despite the differing exposure parameters, pixels of identical brightness are also outputted at identical brightness.

As already outlined, the aforesaid correction matrix can be static or dynamic. In the static case, for example, the image is split into two regions, of which the first encompasses the upper half of the image and the center region of the lower half of the image, and the second region is constituted by the remaining portions of the image. The exposure parameters are selected in such a way that shorter exposure times are produced in the second region than in the first region. This is advantageous in particular because the aforesaid first region is typically the region of the horizon and of the lane, in which dynamic moving objects with strong contrasts are less to be expected than in the second aforesaid region, which typically encompasses the edge of the roadway in the closer vicinity of the vehicle, in which traffic signs, pedestrians, or even crossing vehicles may be expected. As a result of the shortened exposure time in the aforesaid second region, it is nevertheless possible to image sharply the fast-moving objects in the closer vicinity of the vehicle; the reason is chiefly that these objects are usually covered or at least touched by the light cone of the vehicle headlight, so that a shorter exposure time becomes possible.

In an alternative embodiment of the invention, it is likewise possible to use a so-called dynamic correction matrix. For this, the exposure parameters for the individual image regions are defined, and cyclically adapted, using the image data themselves. The so-called optical flow, in particular, can be utilized in this context in order to determine the exposure parameters for a specific image region. In image processing and optical measurement engineering, “optical flow” refers to a vector field that indicates the two-dimensional motion direction and velocity for each image point of an image sequence. The optical flow can thus be understood as the velocity vectors, projected onto the image plane, of visible objects. An image of reduced resolution can be used, in particular, for this purpose in order to minimize the quantity of data to be evaluated for determination of the optical flow and to enable fast signal processing; on the basis of the measured optical flow in at least two continuous regions, it is possible to work respectively with the same set of exposure parameters. The advantage here is that scene-dependent adaptation of the exposure parameters becomes possible.

The image sensing apparatus according to the present invention for application of the method described above exhibits an image sensor having a plurality of pixels, as well as a control unit for setting the exposure parameters of at least one of the pixels. The control unit is suitable for setting different exposure parameters at the same point in time for at least two of the pixels.

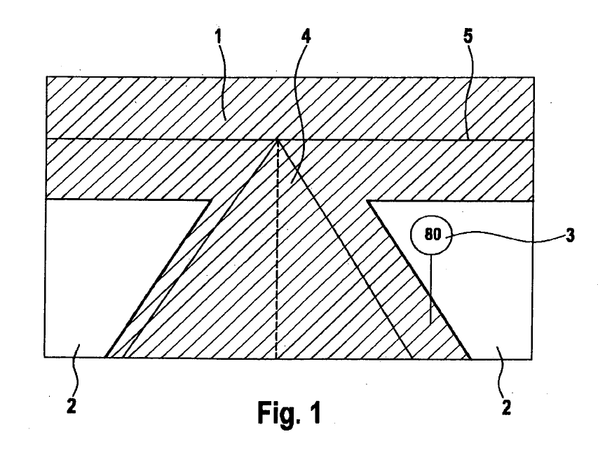

FIG. 1 shows an exemplifying camera image, acquired with the image acquisition apparatus according to the present invention, that is subdivided into first region 1 depicted with hatching, and second region 2. First region 1 of the image encompasses those regions in which objects moving more slowly may be expected, i.e. in particular the central region of the lane with roadway 4, as well as the upper half of the image with horizon line 5. Second region 2 encompasses the surroundings regions of the lane located closer to the vehicle, with traffic signs 3. A separate set of exposure parameters is set for each of the two regions 1 and 2. For region 2, a set of exposure parameter is used which causes shorter exposure times to be applied in region 2 than in region 1. The result of this is that despite the aforementioned high dynamism in region 2, the typically well-illuminated and fast-moving objects in region 2 are imaged with considerably reduced motion blur as compared with region 1, thus yielding globally an optimized image for the observer, i.e. the vehicle driver. The optimization consists in particular in the fact that in region 1, because of the longer exposure times possible therein, even darker objects can still be sensed and presented to the user with sufficient precision. The information content of the image that is sensed by the image sensing apparatus, and presented to the driver or evaluated for an assistance function, is thereby considerably increased, resulting ultimately in an improvement in traffic safety.

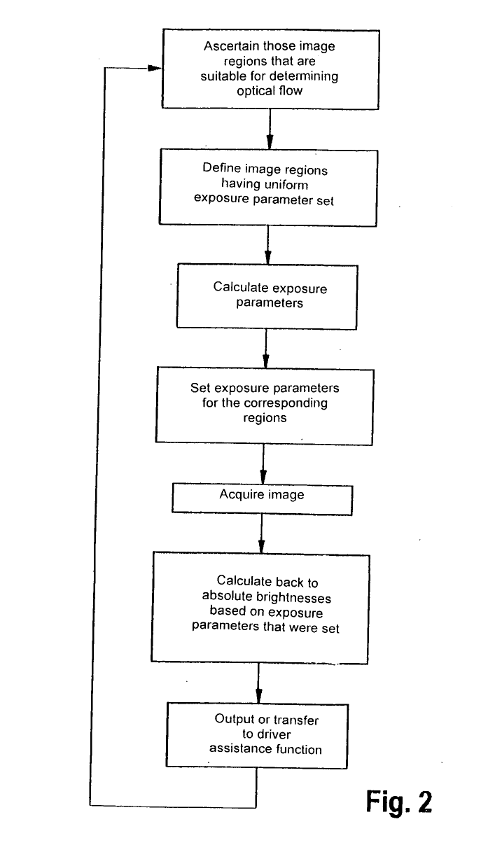

FIG. 2 shows the method according to the present invention in exemplifying fashion, in the form of a flow chart. In a first method step, those image regions that are suitable for determining the optical flow are ascertained. Those image regions in which characteristic textures are present are particularly suitable for this.

A second step then defines those image regions for which, based on the similar circumstances therein, a uniform exposure parameter set can be used.

In a subsequent step the corresponding exposure parameters are calculated, and in a further step they are set for the selected image regions.

The image is then acquired, and a back-calculation to absolute brightness values is performed for the pixels to be outputted, on the basis of the exposure parameters that were set; the image data thereby generated are then conveyed to a driver assistance system for presentation to the driver or for further processing.

The method then returns to step 1.

1-14. (canceled)

15. An image sensing method for a motor vehicle, comprising:
sensing an image of surroundings of the vehicle using an image sensor, the image sensor having the plurality of pixels, and
setting different exposure parameters for at least two of the pixels at the same point in time.

16. The image sensing method as recited in claim 15, wherein the pixels of the image sensor are arranged in rows or columns, and different exposure parameters are set respectively for the pixels of at least two continuous regions of a row or column.

17. The image sensing method as recited in claim 16, wherein a separate set of exposure parameters is set for each pixel.

18. The image sensing method as recited in claim 15, wherein exposure time is used as an exposure parameter.

19. The image sensing method as recited in claim 16, wherein exposure time is used as an exposure parameter.

20. The image sensing method as recited in claim 15, wherein an exposure characteristic curve is used as an exposure parameter.

21. The image sensing method as recited in claim 16, wherein an exposure characteristic curve is used as an exposure parameter.

22. The image sensing method as recited in claim 15, wherein the image is split into two regions, a first region and a second region, wherein the first region encompasses the upper half of the image and the center region of the lower half of the image, and the second region is constituted by the remaining portions of the image, and the exposure parameters are set in such a way that shorter exposure times are produced in the second region than in the first region.

23. The image sensing method as recited in claim 16, wherein the image is split into two regions, a first region and a second region, wherein the first region encompasses the upper half of the image and the center region of the lower half of the image, and the second region is constituted by the remaining portions of the image, and the exposure parameters are set in such a way that shorter exposure times are produced in the second region than in the first region.

24. The image sensing method as recited in claim 15, wherein the exposure parameters are obtained, and cyclically adapted, from image data.

25. The image sensing method as recited in claim 24, wherein the exposure parameters for at least one image region are ascertained using the measured optical flow in that image region.

26. The image sensing method as recited in claim 25, wherein an image having reduced resolution is used to ascertain the exposure parameters using the optical flow.

27. The image sensing method as recited in claim 25, wherein at least one image row is divided, on the basis of the measured optical flow, into at least two continuous regions each having the same set of exposure parameters.

28. The image sensing method as recited in claim 26, wherein at least one image row is divided, on the basis of the measured optical flow, into at least two continuous regions each having the same set of exposure parameters.

29. The image sensing method as recited in claim 15, wherein data made available by an adaptive cruise control system or navigation system are used to set the exposure parameters.

30. The image sensing method as recited in claim 15, further comprising outputting acquired pixels for an image output unit or for a driver assistance system via a data interface, and converting acquired intensity values, in consideration of the exposure parameters, into grayscale values in such a way that despite differing exposure parameters, pixels of identical brightness are outputted at identical brightness.

31. An image sensing apparatus for sensing an image from the surroundings of a vehicle, comprising:
an image sensor having a plurality of pixels, and
a control unit for setting exposure parameters of at least one of the pixels, wherein the control unit is suitable for setting different exposure parameters for at least two of the pixels at the same point in time.

32. The image sensing apparatus as recited in claim 31, wherein the control unit is suitable for carrying out the method as recited in claim 15.
